(19) United States
(12) Patent Application Publication
(10) Pub. No.: US 2015/0116232 A1
(43) Pub. Date: Apr. 30, 2015

(54) PORTABLE INFORMATION TERMINAL

(71) Applicant: Susumu Hayakawa, Osaka-shi (JP)

(72) Inventor: Susumu Hayakawa, Osaka-shi (JP)

(73) Assignee: SHARP KABUSHIKI KAISHA, Osaka-shi, Osaka (JP)

(21) Appl. No.: 14/353,954

(22) PCT Filed: Jul. 18, 2012
(86) PCT No.: PCT/JP2012/068248

§ 371 Date: Nov. 19, 2014

(30) Foreign Application Priority Data
Oct. 27, 2011 (JP) 2011-236524

(51) Int. Cl. G09G 5/38; G06F 3/041

(52) U.S. Cl. CPC G09G 5/38; G06F 3/0412; G09G 2354/00; G09G 2340/0492
USPC 345/173

(57) ABSTRACT

A smart phone (1) of an embodiment of the present invention includes (i) a touch determining section (42) for determining whether or not a touch on a lock region, provided in a peripheral part of a touch panel (2), is detected and (ii) an application executing section (40) for switching, in accordance with a result determined by the touch determining section (42), between enabling and disabling of a specific function.

### TECHNICAL FIELD

The present invention, relates to a portable information terminal including a touch panel.

### BACKGROUND ART

In recent years, portable information terminals such as a mobile phone terminal, smart phone, PDA (Personal Digital Assistant), and tablet. PC (Personal Computer) have been widely used. Such portable information terminals include a touch panel in which a display and a touch sensor are provided in combination. A user can operate various applications by touching such a touch panel.

Such portable information terminals, except a 10 inch tablet PC, are often used as a substitute for a mobile phone terminal. The portable information terminal, whose casing is small in size enough to fit in a pocket of clothes, is popular. In contrast, in order to display a lot of information, the portable information terminal, whose display is large in size, is popular. In order to respond to this trend of demanding a portable information terminal having a smaller casing while having a larger display, so-called a “frame,” which is a remaining part obtained by excluding a display from the casing, tends to be increasingly narrower.

A portable information terminal having a screen rotating function has been put to practical use in order for information to be easily viewable on a small display. The screen rotating function is a function to automatically switch, in accordance with a position of the portable information terminal, between (i) longitudinal display in which a vertical direction of a content to be displayed is parallel to a long side of the display and (ii) lateral display in which a vertical direction of a content to be displayed is parallel to a short side of the display. For example, a portable information terminal, including an acceleration sensor, is capable of recognizing an inclination of the portable information terminal with respect to a horizon plane. This allows (i) the longitudinal display when the portable information terminal is held in a vertical direction (i.e., when an angle between the long side of the display and the horizontal plane is close to 90°) and (ii) the lateral display when the portable information terminal is held in a lateral direction (i.e., when an angle between the long side of the display and the horizon plane is close to 0°).

It is possible for information to be easily viewable even on a small display, by thus rotating the screen in accordance with a position of the portable information terminal. For example, in a case where it is intended to display a longitudinally long picture on the display, the portable information terminal is to be held in a vertical direction so as to carry out a longitudinal display. In a case where it is intended to display a laterally long software keyboard on the display, the portable information terminal is to be held in a horizontal direction so as to carry out a lateral display.

Patent Literature 1 discloses an invention including (i) inputting means for sensing a touch on a display screen, (ii) inclination detecting means for detecting an inclination of a device itself and generates inclination information indicative of a direction of the inclination and a degree of the inclination, and (iii) control means for changing an image to be displayed on the display screen in accordance with inclination information relating to an inclination thus detected while the display screen is kept, being touched by a predetermined touch operation.

Note, however, that the screen rotating function realized by employing the acceleration sensor is convenient, whereas the screen rotating function causes a problem that a rotation of screen which a user does not intend to have. A typical example is a rotation of screen that occurs in a case where a user operates the portable information terminal while lying down. Specifically, in a case where a user lies down while holding the portable information terminal in a vertical direction (the long side of the display is parallel to a median line of the user), an angle between the long side of the display and the horizon plane becomes close to 0°. This causes a longitudinal display to be switched to a lateral display. In this case, the vertical direction of a content becomes orthogonal to the median line of the user, and thus it becomes very difficult to view the content. When rotating the screen, redrawing will be required to update the screen and reload of data from the network is apt to be required. This interrupts an operation the user was working on and leads to remarkably lowered operability. In order to address the problems, a portable information terminal is provided which includes means for disabling the screen rotating function.

### CITATION LIST

### Patent Literature 1

Japanese Patent Application Publication, Tokukai, No. 2011-76349 (Published Date: Apr. 14, 2011).

### SUMMARY OF INVENTION

### Technical Problem

However, the well-known portable information terminal including the means for disabling the screen rotating function is disadvantageously high in cost (special button and switch are built-in) and complicated in operation (it is required to enter a number of menu hierarchies, and it is also not easy to find a menu item). Particularly, as to the latter disadvantage, even in a case where a user wishes, in accordance with a scene of use, to smoothly switch between the longitudinal display and the lateral display or to fix display to one of the longitudinal display and the lateral display, the user feels it troublesome to do so because an extra work is needed. Thus, a user, who sometimes wishes to switch between the longitudinal display and the lateral display, intends to use the portable information terminal in a state where the “screen rotating function is always on” while standing unintended screen rotation that is occasionally carried out. This is not a favorable situation for a user. In order to clear such a situation, an approach has been also made by employing software. As an example, it is possible to toggle between ON and OFF of the screen rotating function by holding down a “search” button provided, as hardware, to a main body. This is easy for operation. However, this is disadvantage in a point that an existing function (search function originally called up by the “search button”) has been cut from the portable information terminal.

In the case where it is intended to narrow down a frame to make an entire screen be a touch panel as described above, as shown in regions enclosed by a dashed line in FIG. 11, a user involuntarily touches his/her finger(s) or part of his/her hand to a part of the screen. Because of this, configurations of conventional portable information terminals have been often devised so that icons are not provided in such a touch region.

### Solution to Problem

The inventors, etc. have found that, as a result of their diligent examination, a portable information terminal which is excellent in operability can be provided, by switching, in accordance with whether or not the user holds the portable information terminal, between enabling and disabling each function without any particular operation. Accordingly, the inventors, etc. have achieved the present invention of the subject application. That is, an object of the present invention is to provide a portable information terminal which is excellent in operability.

In order to attain the foregoing object, the portable information terminal of the present invention includes: a touch panel; touch determining means for determining whether or not a touch on a specific region, provided in a peripheral part of the touch panel, is detected; and switching means for switching, in accordance with a result determined by the touch determining means, between enabling and disabling of a specific function.

With the configuration, the specific region is provided in the peripheral part of the touch panel in which peripheral part a user involuntarily touches with his/her hand and/or finger(s) while holding the portable information terminal. As such, whether to enable or disable each function can be switched, without any particular operation, in accordance with whether or not the user holds the portable information terminal.

A touch can be detected by a touch sensor that constitutes the touch panel. This eliminates (i) the need for separate provision of a new device and/or a member for detecting such a touch and (ii) the need for separate provision of a particular manufacturing process and separate manufacturing cost.

In order to attain the foregoing object, a method of controlling the portable information terminal of the present invention is a method of controlling of a portable information terminal including a touch panel, the method including the steps of: (a) determining whether or not a touch on a specific region, provided in a peripheral part of the touch panel, is detected, and (b) switching, in accordance with a result determined in the step (a), between enabling and disabling of a specific function.

With the configuration, the specific region is provided in the peripheral part of the touch panel in which peripheral part a user involuntarily touches with his/her hand and/or finger(s) while holding the portable information terminal. As such, whether to enable or disable each function can be switched, without any particular operation, in accordance with whether or not the user holds the portable information terminal.

### Advantageous Effects of Invention

According to the present invention, it is possible to provide a portable information, terminal in which whether to enable or disable each function can be switched, without any particular operation, in accordance with whether or not the user holds the portable information terminal.

### BRIEF DESCRIPTION OF DRAWINGS

FIG. 1(a) is a block diagram illustrating configuration of a portable information terminal of one embodiment of the present invention.

FIG. 1(b) is a block diagram illustrating a configuration of a portable information terminal of one embodiment of the present invention.

FIG. 2 is an elevational view of the portable information terminal shown in FIG. 1.

FIG. 3 is views illustrating a state in which a user holds the portable information terminal shown in FIG. 1.

(a) of FIG. 4 and (b) of FIG. 4 are a perspective view and a cross-sectional view, respectively, each illustrating an example of an exterior appearance of the portable information terminal shown in FIG. 1.

FIG. 5 is a flowchart showing a process carried out by a control means included in the portable information terminal shown in FIG. 1.

FIG. 6(a) is a view illustrating a modification of the portable information terminal shown in FIG. 1.

FIG. 6(b) is a view illustrating a modification of the portable information terminal shown in FIG. 1.

FIG. 6(c) is a view illustrating a modification of the portable information terminal shown in FIG. 1.

FIG. 7 is a flowchart showing a process carried out by the control means included in the portable information terminal shown in FIG. 1.

FIG. 8 is a block diagram illustrating a configuration of a portable information terminal of another embodiment of the present invention.

FIG. 9 is a flowchart showing a process carried out by the control means included in the portable information terminal shown in FIG. 8.

FIG. 10 is a flowchart showing a process carried out by a control means included in a portable information terminal of another embodiment of the present invention.

FIG. 11 is a view showing a problem of a conventional configuration.

### DESCRIPTION OF EMBODIMENTS

### Embodiment 1

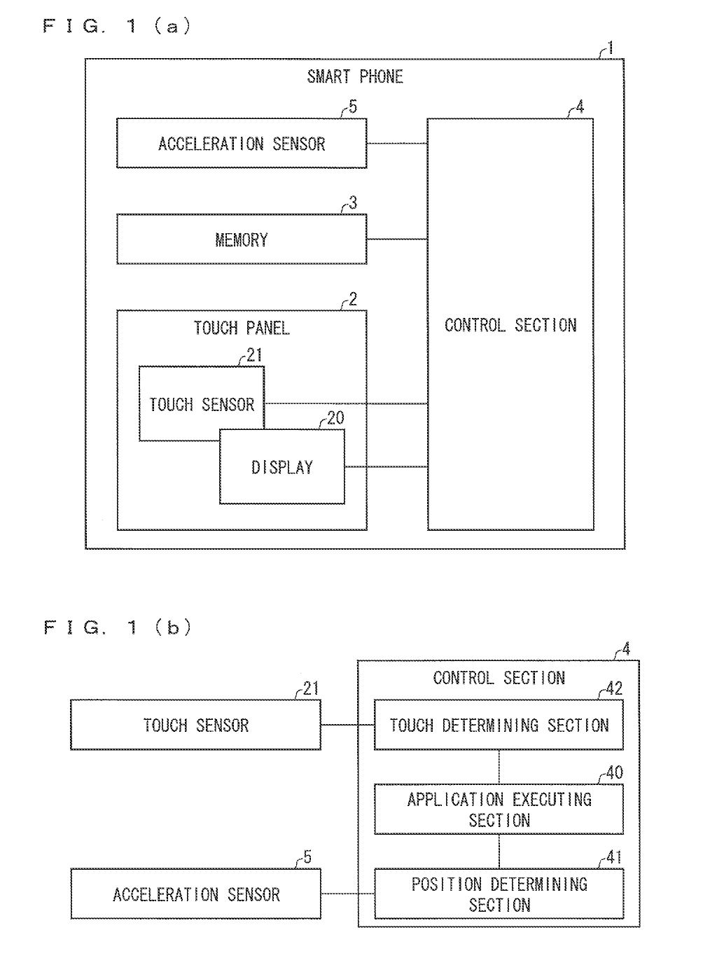

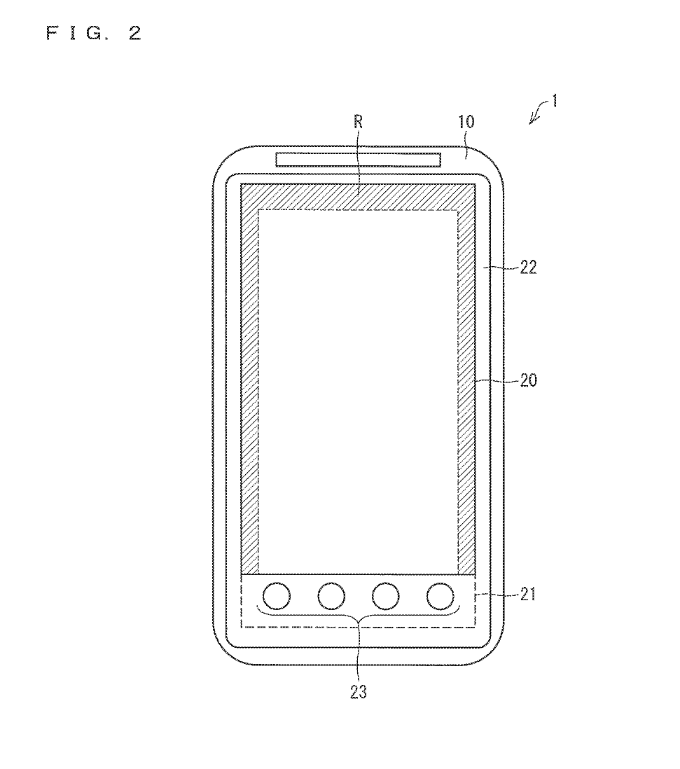

A portable information terminal of Embodiment 1 in accordance with the present invention will be described below with reference to FIG. 1(a), and FIGS. 2 through 4. Note that, since the portable information terminal of Embodiment 1 has been achieved by a smart phone, the portable information terminal is hereinafter referred to as a smart phone. Note, however, that, as will be clear from the following description, the applicable scope of the present invention is not limited to the smart phone and is therefore widely applicable to other portable information terminals such as mobile phone terminal, smart phone, PDA (Personal Digital Assistant), and tablet PC (Personal Computer).

A configuration of a smart phone 1 of Embodiment 1 will be described below with reference to FIG. 1(a). FIG. 1 (a) is a block diagram illustrating a configuration of the smart phone 1. Note that FIG. 1(a) illustrates only components, out of components included in the smart phone 1, that directly relate to the present invention. As such, the smart phone 1 does not exclude inclusion of components other than the components illustrated in FIG. 1(a).

The smart phone 1 of Embodiment 1 includes a touch panel 2, a memory 3, a control section 4, and an acceleration sensor 5 (see FIG. 1(a)).

The touch panel 2 includes a display 20 for displaying various screens. Each screen to be displayed on the display 20 is generated by the control section 4. Note that a transparent liquid crystal panel, including a backlight, can be employed as the display 20. Note, however, that Embodiment 1 is not limited to this.

The touch panel 2 further includes a touch sensor 21 that detects a touch made by an object (e.g., a finger of a user). The touch sensor 21 supplies the control section 4 with positional information indicative of a touch position thus detected (e.g., coordinates of a touch position). Note that a conventionally well-known configuration can be employed as the touch sensor 21. In a case where the display 20 is, for example, a liquid crystal display device, an electrode of the liquid crystal display device can be shared as an electrode for the touch panel.

The acceleration sensor 5 (i) detects an inclination of the smart phone 1 with respect to a direction of gravity exerted on the touch panel 2 and (ii) supplies the control section 4 with inclination information indicative of inclination thus detected (e.g., an angle between a long side of the touch panel 20 and the horizon plane).

The control section 4 executes various application programs. An application program (i) operates with reference to the positional information received from the touch sensor 21 and the inclination information received from the acceleration sensor 5 and (ii) generates various screens containing user interface and contents. A screen generated by an application program is displayed on the display 20 of the touch panel 2 as described earlier. Note that functions of the control section 4 will be later described in detail with reference to another drawing.

The memory 3 is a non-volatile memory used as an auxiliary storage device. In addition to the above application programs, the memory 3 stores various data generated by the application programs or various data to be referred to. Note that a flash memory can be employed as the memory 3. Note, however, that Embodiment 1 is not limited to this.

Next, a function of the control section 4 will be described with reference to FIG. 1(b). FIG. 1(b) is a functional block diagram showing a function of the control section 4. Note that FIG. 1(b) shows only functions, out of the functions of the control section 4, that directly relate to the present invention. As such, the control section 4 does not exclude inclusion of functions other than the functions illustrated in FIG. 1(b).

The control section 4 functions as an application executing section 40, a position determining section 41, and a touch determining section 42 (see FIG. 1(b)).

The application executing section 40 is means for executing various application programs. Representative examples of an executable application by the application executing section 40 encompass, but not limited to, Web browser, an electronic mail client, a word processor, and a media player. Examples of application also encompass GUI front-end of an operating system.

The position determining section 41 determines, in accordance with the inclination information received from the acceleration sensor 5, whether the smart phone 1 is held in a vertical direction or in a horizontal direction. Specifically, the position determining section 41 determines that “the smart phone 1 is held in a horizontal direction” in a case where angle θ satisfies an inequality 0°≦θ<Th and otherwise determines that “the smart phone 1 is held in a vertical direction,” where the angle θ (0°≦θ≦90°) indicates the inclination information and is defined as an angle between a long side of the touch panel 2 and the horizon plane. Note here that Th is a predetermined threshold and, for example, Th=45°. A result determined by the position determining section 41 is referred to by the application executing section 40 so as to carry out the screen rotating function.

Note that, instead of the determining method described above, another determining method can be employed in which, (i) in a case where θ falls below 40° (=Th) while the smart phone 1 is being held in a vertical direction, the position determining section 41 determines that the smart phone 1 is changed to a state where it is held in a vertical direction and (ii) in a case where θ exceeds 50° (=Th) while the smart phone is held in a horizontal direction, the position determining section 41 determines that the smart phone 1 is changed to a state where it is held in a vertical direction. By employing such a determining method in which hysteresis is introduced, it is possible to avoid a situation in which the determination result frequently fluctuates at a boundary between a state in which the smart phone 1 is held in a vertical direction and a state in which the smart phone 1 is held in a horizontal direction.

The result determined by the position determining section 41 is referred to by the application executing section 40 so as to carry out the screen rotating function. Specifically, in a case where a result determined by the position determining section 41 indicates that “the smart phone 1 is held in a vertical direction”, the application executing section 40 carries out longitudinal display on a screen. In contrast, a result determined by the position determining section 41 indicates that “the smart phone 1 is held in a horizontal direction”, the application executing section 40 carries out lateral display on the screen.

Note here that the longitudinal display indicates a display mode in which a vertical direction of a content displayed on the screen is parallel to a long side of the display 20, whereas the lateral display indicates a display mode in which the vertical direction of the content displayed on the screen is parallel to a shorter side of the display 20. Note that the screen rotating function can be enabled or disabled. In the present specification, disabling of the screen rotating function is also referred to as “locking of the screen rotation”.

The touch determining section 42 determines, in accordance with the positional information received from the touch sensor 21, whether or not an object (a finger or a hand of a user) touches a specific region (hereinafter, referred to as a “lock region R) on the touch panel 2. Specifically, in a case where an object touches a position on the touch panel 2, the touch determining section 42 (i) receives coordinates (x, y) from the touch sensor 21 and (ii) determines that “lock region R is touched” in a case where the coordinates (x, y) satisfy (x, y)∈R and otherwise determines that “lock region R is not touched.” Note that which region on the touch panel 2 is to be referred to as the lock region R will be later described with reference to drawings.

The result determined by the touch determining section 42 is referred to by the application executing section 40 so that the screen rotating function is determined whether to be enabled or disabled. Specifically, the application executing section 40 (i) disables the screen rotating function in a case where the result determined by the touch determining section 42 is that “the lock region R is touched,” whereas enables the screen rotating function in a case where the result determined by the touch determining section 42 is that “the lock region R is not touched”.

With the configuration in which the control section 4 has the function described above, it is possible to provide a smart phone 1 in which a screen is rotated in accordance with a position of the smart phone 1 in a case where the lock region R is not touched, whereas the screen is not rotated in accordance with the position of the smart phone 1 in a case where the lock region R is touched.

The following description will discuss the lock region R with reference to FIG. 2. FIG. 2 is an elevational view of an exterior appearance of the smart phone 1.

The smart phone 1 includes a casing 10 having a flat rectangular parallelepiped shape, and the touch panel 2 is mounted on one of principle surfaces of this casing 10 (see FIG. 2). The display 20 and the touch sensor 21 each have a rectangular shape, and are provided so that their left ends, right ends, and upper ends completely overlap each other.

There is provided, underneath the display 20, an input accepting section 23 made up of four touch sensor buttons. A lower part of the touch sensor 21 projects from the lower end of the display 20 so that a touch to the four touch sensor buttons is detected. The display 20 is surrounded by a region 22, which region is often called as a “frame” (hereinafter referred to as “frame part 22”).

The lock region R is provided in a peripheral part of the touch panel 2. Embodiment 1 employs a lock region R having a U-shape made up of three strip-shaped regions along respective of two long sides (the left end and the right end) and one short side (the upper end) of the touch panel 2 (see FIG. 2). Note that the two strip-shaped regions along the respective long sides of the touch panel 2 are ended at the lower end of the display 20, and the lock region R is not provided in the other short side (lower end) of the touch panel 2.

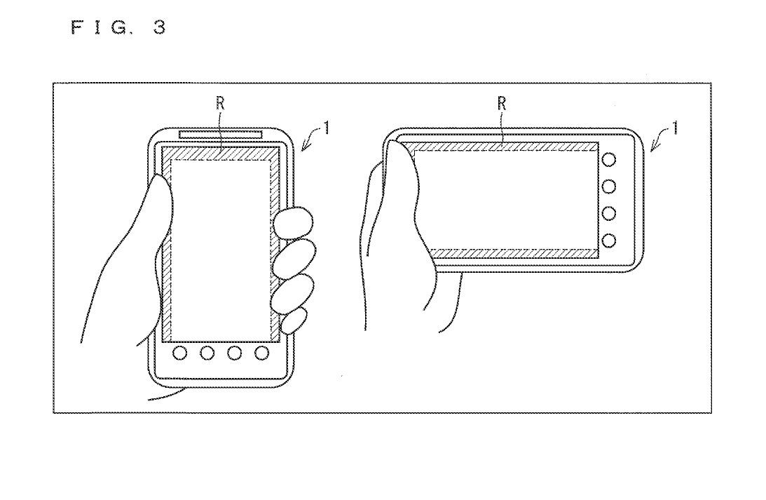

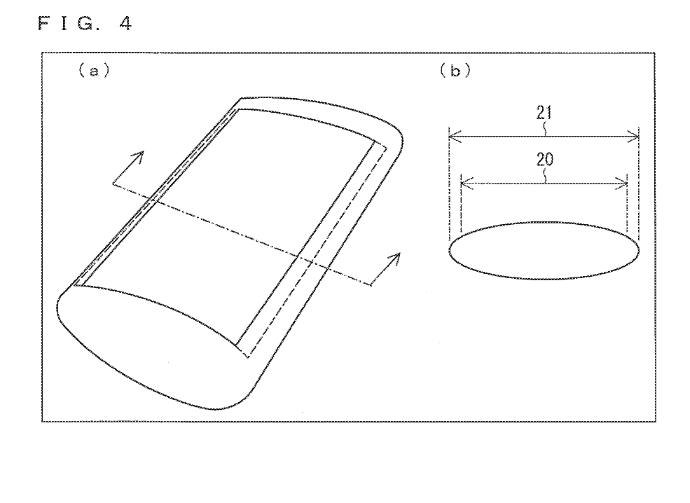

The provision of the lock region R as illustrated in FIG. 2 has some advantages. First, while a user is holding the smart phone 1 in a vertical direction, fingers and/or palm of the user partly touches the left end and the right end of the touch panel 2 (see a left-side view of FIG. 3). While the user is holding the smart phone 1 in a horizontal direction, fingers and/or hand of the user partly touches the upper end of the touch panel 2 (see a right-side view of FIG. 3).

In a case where the lock region R is provided as illustrated in FIG. 2, the fingers and/or the palm of the user always partly touch the lock region R while the user is holding the smart phone 1. While the user is holding the smart phone 1, the lock region R is kept being touched by the user. Because of this, while the user is holding the smart phone 1, unnecessary screen rotation will not occur even in a case where the user lies down. In contrast, in a case where the user changes to hold the smart phone 1 from a vertical direction to a horizontal direction (or vice versa), the user inevitably leaves fingers and/or palm from the lock region R, so that necessary screen rotation occurs.

Furthermore, it is rare that UI elements such as an icon and a menu are provided at the left end, right end, and upper end of the display panel 2. That is, in a case where the lock region R is provided as illustrated in FIG. 2, it is possible to effectively utilize a region on the display 20 which has not been conventionally used. In addition, there is no chance to make it impossible to determine whether the UI element is touched or the lock region R is touched.

A size of the lock region R can be appropriately determined by taking into consideration the sizes of respective of the smart phone 1, the display 20, and the frame part 22, a shape of a cross section of the casing 10, and the like. In this case, the size of the lock region R can be determined by measuring how much fingers and/or palm of a user overlap with the peripheral part of the touch panel 2 while the user is holding the smart phone 1. In a case where (i) the casing 10 is, for example, 123 mm by 68 mm in size and 11.8 mm in thickness and (ii) the display 20 is 93 mm by 55 mm in size, a region extending (i) up to approximately 10 mm inward from each of the left end and the right end of the casing 10 (6.5 mm out of 10 mm is for the frame part 22) and a region extending (ii) up to approximately 15 mm inward from the upper end of the casing 10 (9 mm out of 15 mm is for the frame part 22) can be employed as the lock region R.

Note that the lock region R is U-shaped and is not provided in the lower end of the touch panel 2 (see FIG. 2). This is because the user wishes to hold the smart phone 1 so as to get around the lower end of the touch panel 2 in which the input accepting section 23 is provided. Note that, in a case where the user holds the smart phone 1 while putting his/her fingers and/or palm on the lower end of the touch panel 2, a wrong operation to the input accepting section 23 will be caused.

Note that, according to Embodiment 1, the left and right ends of the touch sensor 21 are provided so as to completely overlap with the left and right ends of the display 20, respectively. Note, however, that the present invention is not limited to this. Alternatively, the touch sensor 21 can employ a configuration in which the left end/right end thereof projects, in a lateral direction, from the left end/right end of the display 20. With such a configuration, even in a case where the frame part 22 is large in width (particularly, a width between a left end of the casing 10 and a left end of the display 20/a width between a right end of the casing 10 and a right end of the display 20), it is possible to definitely detect the user holding the smart phone 1.

Such a configuration is effective especially in a case of employing a smart phone 1 which is designed so that its surface is curved. (a) of FIG. 4 is a perspective view of such a smart phone 1, and (b) of FIG. 4 is a cross-sectional view of the smart phone 1. The casing 10 is configured so as to have a principle surface and a side surface which are seamlessly connected to each other and so that the left end/right end thereof projects, in a lateral direction, from the left end/right end of the display 20 (see (b) of FIG. 4). This makes it possible to provide, as a lock region R, a part where fingers and/or palm of the user are put while naturally holding the smart phone 1.

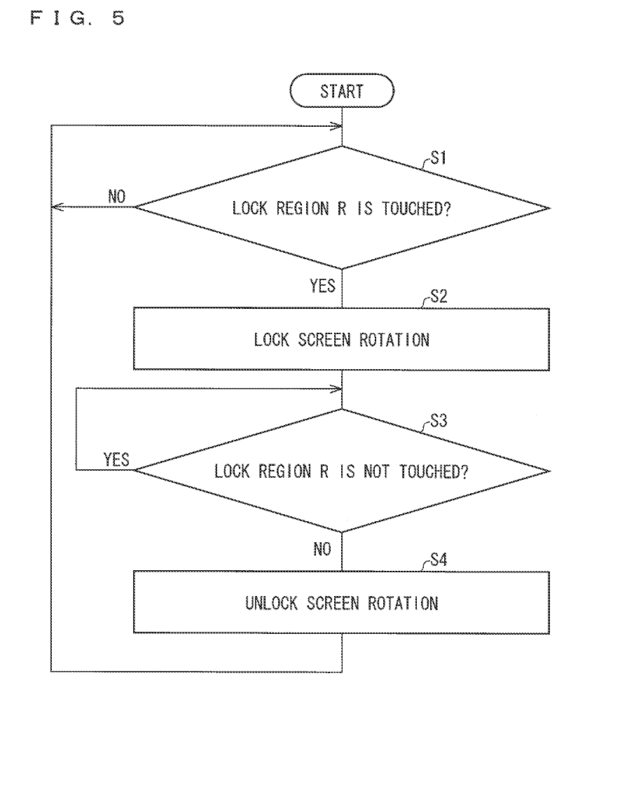

The following description will discuss a flow of a screen rotation locking process carried out in the smart phone 1 with reference to FIG. 5. FIG. 5 is a flowchart showing the screen rotation locking process carried out in the smart phone 1.

In step S1, the touch determining section 42 determines, in reference to the positional information received from the touch sensor 21, whether or not an object (fingers and/or palm of a user) touches the lock region R. In a case where the touch determining section 42 determines that “the lock region R is touched,” the process proceeds with step S2.

in step S2, the application executing section 40 disables the screen rotating function. While the screen rotating function is being disabled, the application executing section 40 does not carry out screen rotation in accordance with the inclination information received from the acceleration sensor 5. Accordingly, until the screen rotating function is enabled again in step S4, the screen rotation does not occur even in a case where a position of the smart phone 1 changes.

In step S3, the touch determining section 42 determines, in reference to the positional information received from the touch sensor 21, whether or not the object (the fingers and/or palm of the user) is left from the lock region R. In a case where the touch determining section 42 determines that “the lock region R is not touched” (the object is left from the lock region R), the process proceeds with step S4.

In step S4, the application executing section 40 enables the screen rotating function. While the screen rotating function is enabled, the application executing section 40 carries out the screen rotation in accordance with the inclination information received from the acceleration sensor 5. Accordingly, until the screen rotating function is disabled again in step S1, the screen rotation is carried out in response to a change in the position of the smart phone 1.

Note here that the description above has discussed the configuration in which the screen rotating function is disabled immediately after it is determined that the lock region R is touched. Note, however, that the present invention is not limited to this. Alternatively, a configuration can be employed in which (i) the screen rotating function is disabled only in a case where an object has kept touching on the lock region R for not less than a predetermined period (e.g., 3 seconds to 10 seconds) or (ii) the screen rotating function is enabled only in a case where an object has kept being away from the lock region R for not less than a predetermined period.

Note that Embodiment 1 has discussed the case where the screen rotation is locked (disabled) merely in a case where a touch on the lock region R is detected. Note, however, that the present invention is not limited to this, and, in addition thereto, a menu for locking the screen rotation can be provided in a menu hierarchy.

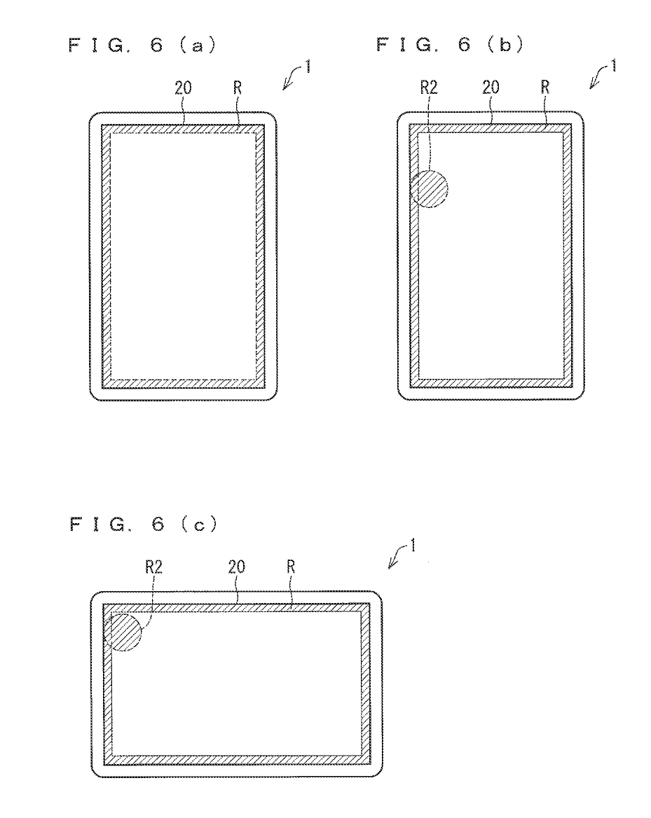

Furthermore, Embodiment 1 has discussed the configuration in which the lock region R has a U-shape and is not provided on the lower end of the touch panel 2, but the present invention is not limited to this. For example, in a case of a configuration in which no input accepting section 23 is provided underneath the display 20, a configuration can be employed in which a lock region R has four strip-shaped regions along respective of two long sides (left and right ends) and two short sides (upper and lower ends) of the touch panel 2 (see FIG. 6(a)).

Alternatively, a configuration can be employed in which an extended region R2 (see FIGS. 6(b) and 6(c)), which is like an icon, is provided in addition to the four strip-shaped regions illustrated in FIG. 6(a). The following description will discuss such an extended region R2.

In each of the cases where a user holds the smart phone 1 in a vertical direction and a horizontal direction, it is preferable to arrange the extended region R2 so that a user can naturally touch with a hand that holds the smart phone 1. Example cases illustrated in respective FIGS. 6(b) and 6(c) are based on the assumption that a user holds the smart phone 1 with the left hand and operates a lock operation with the thumb of the left hand. It is preferable to indicate the extended region R2 through a graphical expression, for example, to display a range defined by an icon or line-drawing so that a user knows that a screen lock function is carried out while touching the extended region R2. It is further preferable to inform a user that the lock function of the screen rotation is carried out by changing how to display the icon or the range. This enables a user to more purposefully operate on/off of locking of the screen rotation.

Note that a configuration can be alternatively employed in which at least one of a position and a size of the extended region R2 is set in accordance with user operation. The control section 4 can control such a setting so that the setting is carried out in accordance with user's operation(s) with respect to the touch panel 22 etc.

### Function Effect of Embodiment 1

As described above, according to Embodiment 1, the control section 4 disables the screen rotating function in a case where the touch sensor 21 detects the lock region R being touched with a finger(s) and/or palm of a user. The lock region R is provided in the peripheral part of the touch panel 2 where the user touches with his/her finger(s) or palm while naturally holding the smart phone 1. Therefore, the user can lock the screen rotating function in an extremely simple method, without being given a feeling of purposefully locking. Since no UI element is provided in the peripheral part of the touch panel 2, operability with respect to the UI elements can also be therefore maintained.

Since a touch on the lock region R can be detected by the touch sensor 21 that constitutes the touch panel 2, there are (i) no need for separate provision, of a new device and/or a member for detecting a touch on the lock region R and (ii) no need for separate provision of a particular manufacturing process and separate manufacturing cost incurred by providing the lock region R.

It is therefore possible to provide the smart phone 1 which is excellent in operability and inexpensively carries out the lock function.

### Embodiment 2

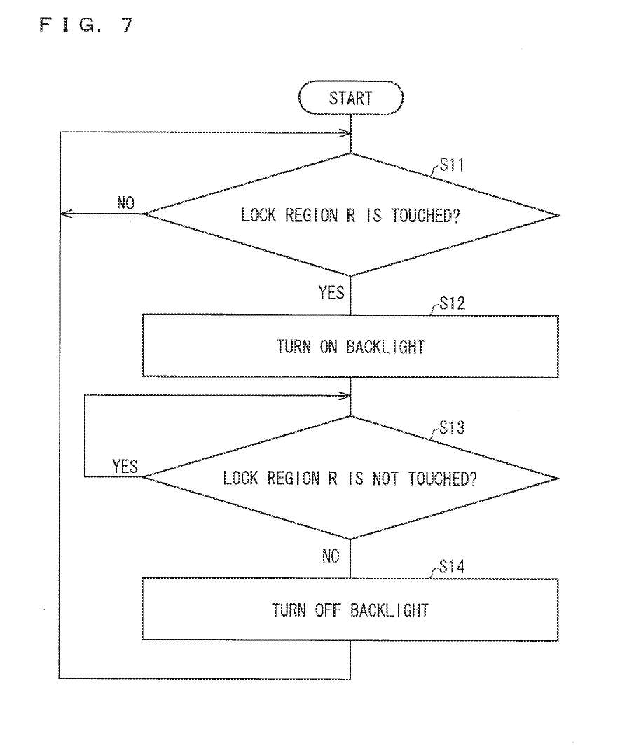

Embodiment 2 of the present invention will be described below with reference to FIG. 7. Note that, since differences will be described between Embodiment 1 and Embodiment 2, members that have functions identical to those described in Embodiment 1 are, for convenience, given identical reference numerals, and are not described repeatedly.

According to Embodiment 1, in a case where a touch is detected on the lock region R (see FIG. 2) provided in the frame part of the display 20 illustrated in FIG. 1(a), the screen rotating function is disabled. On the other hand, according to Embodiment 2, a smart phone 1 is controlled by the control section 4 so as to carry out (i) a function of turning on a backlight while a touch is being detected on the lock region R and (ii) a function of turning off the backlight while a touch is not being detected.

From the view point of low power consumption, the smart phone 1 of Embodiment 2 is controlled so that a backlight of the display 20 is turned off while a user is not using the display 20. Such controlling is carried out by the control section 4 as with Embodiment 1.

FIG. 7 is a flowchart showing a process carried out in a case where the control section 4 turns on the backlight.

In step S11, the touch determining section 42 illustrated in FIG. 1(b) determines, in reference to the positional information received from the touch sensor 21, whether or not the object (the fingers and/or palm of the user) touches the lock region R. In a case where the touch determining section 42 determines that “the lock region R is touched”, the process proceeds with step S12.

In step S12, the control section 4 controls the backlight of the display 20 to be turned on.

In step S13, the touch determining section 42 illustrated in FIG. 1(b) determines, in reference to the positional information received from the touch sensor 21, whether or not the object (the fingers or palm of the user) is left from the lock region R. In a case where the touch determining section 42 determines that “the lock region R is not touched”, the process proceeds with step S14.

In step S14, the control section. 4 controls the backlight to be turned off.

Note that the backlight can be turned on, for example, in response to entering of an input via the input accepting section 23 or in response to pressing of a power button.

### Function Effect of Embodiment 2

As described above, according to Embodiment 2, the control section 4 turns on the backlight in a case where the touch sensor 21 detects the lock region R being touched with a finger(s) or palm of a user. The lock region R is provided in a peripheral part of the touch panel 2 where the user touches with his/her finger(s) or palm while naturally holding the smart phone 1. Therefore, the user can turn on the backlight in an extremely simple method, without being given a feeling of purposefully turning on the backlight. Since no UI element is provided in the peripheral part of the touch panel 2, operability with respect to the UI elements can also be therefore maintained.

Since a touch on the lock region R can be detected by the touch sensor 21 that constitutes the touch panel 2, there are (i) no need for separate provision of a new device and/or a member for detecting a touch on the lock region R and (ii) no need for separate provision of a particular manufacturing process and separate manufacturing cost incurred by providing the lock region R.

It is therefore possible to provide the smart phone 1 which is excellent in operability and inexpensively carries out the lock function.

It is possible to reduce power consumption of the portable information terminal and therefore to extend operation hours by controlling the backlight in this manner.

(Modification)

From the view point of low power consumption as with Embodiment 2, instead of controlling the backlight to be turned off, a portable information terminal system can be put into a standby state or put into a low-power consumption state which is similar to the standby state.

### Embodiment 3

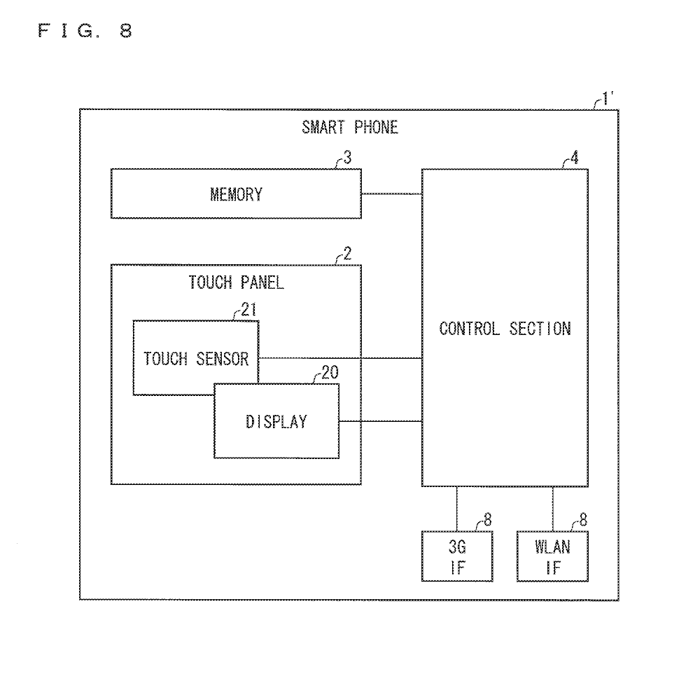

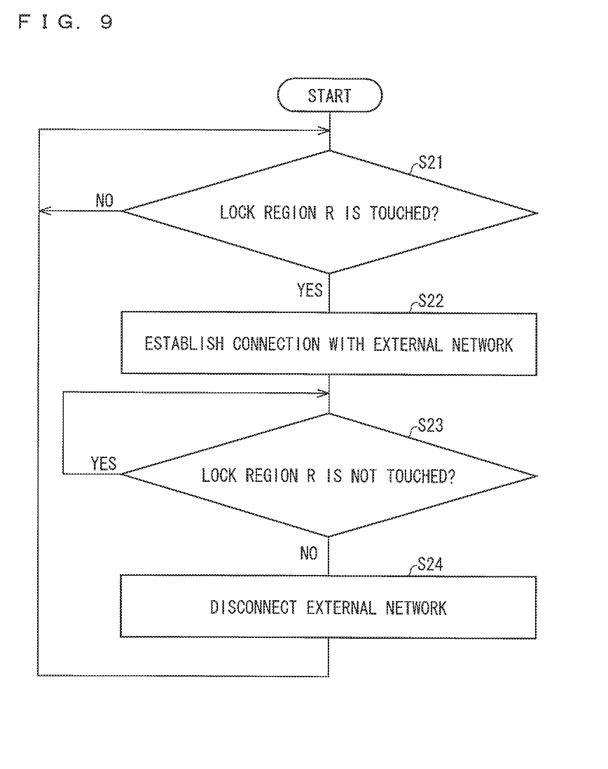

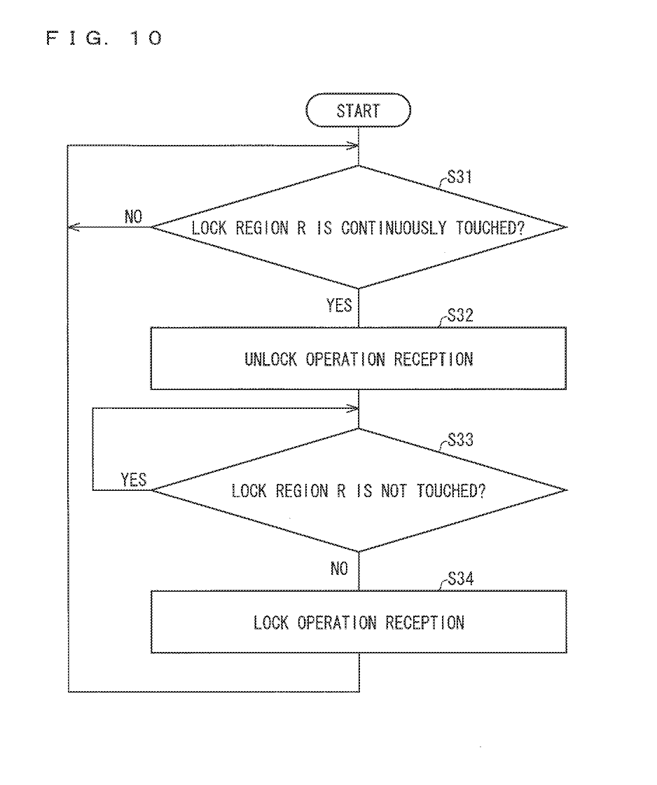

Embodiment 3 of the present invention will, be described below with reference to FIGS. 8 and 9. Note that, since differences will be described between Embodiment 1 and Embodiment 3, members that have functions identical to those described in Embodiment 1 are, for convenience, given identical reference numerals, and are not described repeatedly.

FIG. 8 is a block diagram illustrating a configuration of a portable information terminal of Embodiment 3. A smart phone 1′ of Embodiment 3 includes a communication interface 8 which is under the control of a control section 4 (see FIG. 8). According to Embodiment 1, the screen rotation is to be locked. On the other hand, according to Embodiment 3, the control section 4 controls the communication interface 8 to start a communication, in a case where a touch sensor 21 detects a lock region R (see FIG. 2), provided in a frame part of a display 20 illustrated in FIG. 1(a), having kept being touched.

FIG. 9 is a flowchart showing a process in which the control section 4 controls a communication interface 8.

In step S21, the touch determining section 42 illustrated in FIG. 1(b) determines, in reference to the positional information received from the touch sensor 21, whether or not the object (the fingers and/or palm of the user) touches the lock region R. In a case where the touch determining section 42 determines that “the lock region R is touched”, the process proceeds with step S22.

In step S22, the control section 4 controls the communication interface 8 to start a communication.

In step S23, the touch determining section 42 illustrated in FIG. 1(b) determines, in reference to the positional information received from the touch sensor 21, whether or not the object (the fingers or palm of the user) is left from the lock region R. In a case where the touch determining section 42 determines that “the lock region R is not touched” (the object is left from the lock region R), the process proceeds with step S24.

In step S24, the control section 4 controls the communication interface 8 to stop the communication.

Note that it is possible to employ a conventionally well-known communication line as an external network communication line.

### Functional Effect of Embodiment 3

As described above, according to Embodiment 3, the control section 4 controls the communication interface 8 to start the communication in a case where the touch sensor 21 detects the lock region R being touched with a finger(s) or palm of a user. The lock region R is provided in a peripheral part of the touch panel 2 where the user touches with his/her finger(s) or palm while naturally holding the smart phone 1′. Since no UI element is provided in the peripheral part of the touch panel 2, operability with respect to the UI elements can also be maintained.

Since a touch on the lock region R can be detected by the touch sensor 21 that constitutes the touch panel 2, there are (i) no need for separate provision of a new device and/or a member for detecting a touch on the lock region R and (ii) no need for separate provision of a particular manufacturing process and separate manufacturing cost incurred by providing the lock region R.

It is therefore possible to provide the smart phone 1 which is excellent in operability and inexpensively carries out the lock function.

Furthermore, according to Embodiment 3, in a case where an object has kept not touching on the lock region R for a predetermined period, the control section 4 controls the communication interface 8 to disconnect the communication. This makes it possible to reduce power consumption of the portable information terminal and therefore to extend operation hours.

Note here that the control section 4 controls the communication interface 8 to disconnect the communication in a case where an object has kept not touching on the lock region R for a predetermined period, not immediately after the object has not touched the lock region R. Accordingly, the communication line is not disconnected each time in a case where a user changes a state in which the user holds the display 20 in a vertical direction into a state in which the user holds the display 20 in a horizontal direction as illustrated in FIG. 3. Thus, the user does not feel stressed. Note that such a predetermined period can be set by a user in accordance with a usage condition of the user. Specifically, the predetermined period can be set to approximately 10 seconds to 30 minutes.

(Modification)

According to Embodiment 3, the control section 4 controls the communication interface 8 to start or stop a communication in accordance with whether or not an object has kept touching on the lock region R. Note, however, that the present invention is not limited to this. Alternatively, a configuration can be employed in which, in a case where (i) the communication interface 8 enables a communication with a plurality of external network communication lines and (ii) an object has kept not touching the lock region R for a predetermined period, the communication interface 8 disconnects the plurality of external network communication lines except communication line that has the lowest power consumption. Alternatively, a configuration can be employed in which, in a case where (i) the communication interface 8 enables a communication with a plurality of external network communication lines and (ii) an object has kept not touching the lock region R for a predetermined period, the communication interface 8 disconnects the plurality of external network communication lines except a communication line that has been selected in advance by a user.

### Embodiment 4

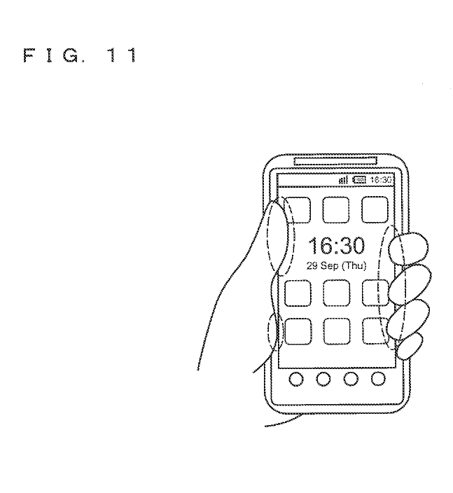

Embodiment 4 of the present invention will be described below with reference to FIG. 10. Note that, since differences will be described between Embodiment 1 and Embodiment 4, members that have functions identical to those described in Embodiment 1 are, for convenience of description, given identical reference numerals, and are not described repeatedly.

According to Embodiment 1, in a case where a touch is detected on the lock region R (see FIG. 2) provided in the frame part of the display 20 illustrated in FIG. 1(a), the screen rotating function is disabled. On the other hand, according to Embodiment 4, it is possible to select and execute a display item only in a case where an object has kept touching a lock region R. This selection and execution is controlled by the control section 4. That s, in a case where an object has kept not touching the lock region R, “operation” such as selection and execution of a display item is locked, whereas in a case where an object has kept touching the lock region R, the operation can be executable.

FIG. 10 is a flowchart showing a process in which the control section 4 controls an operation of display item.

In step S31, the touch determining section 42 illustrated in FIG. 1(b) determines, in reference to the positional information received from the touch sensor 21, whether or not the object (the fingers and/or palm of the user) touches the lock region R. In a case where the touch determining section 42 determines that “the lock region R is touched”, the process proceeds with step S32.

In step S32, operation lock is unlocked based on controlling by the control section 4 so that a display item can be selected and executed.

In step S33, the touch determining section 42 illustrated in FIG. 1(b) determines, in reference to the position information received from the touch sensor 21, whether or not the object (the finger and/or palm of the user) is left from the lock region R. In a case where the touch determining section 42 determines that “the lock region R is not touched” (the object is left from the lock region R), the process proceeds with step S34.

In step S14, the operation is locked, based on controlling by the control section 4.

### Functional Effect of Embodiment 4

As described above, according to Embodiment 4, only in a case where an object has kept touching on the lock region R, the operation lock is unlocked based on the controlling by the control section 4 so that a display item can be selected and executed. The lock region R is provided in a peripheral part of the touch panel 2 where fingers and/or palm of the user are put while naturally holding the smart phone 1. Since no UI element is provided in the peripheral part of the touch panel 2, operability with respect to the UI elements can also be therefore maintained.

Since a touch on the lock region R can be detected by the touch sensor 21 that constitutes the touch panel 2, there are (i) no need for separate provision of a new device and/or a member for detecting a touch on the lock region R and (ii) no need for separate provision of a particular manufacturing process and separate manufacturing cost incurred by providing the lock region R.

Such controlling allows for prevention of a function associated with a corresponding display item on a display surface from being selected and executed, for example, in a case where a hand involuntarily touches the display surface (namely, touch panel surface) while holding the display surface on a palm side or in a case where an object touches the display surface in a bag etc.

The present invention is not limited to the descriptions of the embodiments above, but may be altered by a person skilled in the art within the technical scope of the claims. An embodiment derived from a common general technical knowledge or a proper combination of the embodiments is also encompassed in the technical scope of the present invention.

(Conclusion of Present Invention)

In order to address the foregoing problems, a portable information terminal of the present invention includes: a touch panel, touch determining means for determining whether or not a touch on a specific region, provided in a peripheral part of the touch panel, is detected, and switching means for switching, in accordance with a result determined by the touch determining means, between enabling and disabling of a specific function.

With the configuration, the specific region is provided in the peripheral part of the touch panel in which peripheral part a user involuntarily touches with his/her hand and/or finger(s) while holding the portable information terminal. As such, whether to enable or disable each function can be switched, without any particular operation, in accordance with whether or not the user holds the portable information terminal.

A touch can be detected by the touch sensor that constitutes the touch panel. This eliminates (I) the need for separately providing a new device and/or a member for detecting such a touch and (ii) the need for separate provision of a particular manufacturing process and separate provision of manufacturing cost.

In addition to the configuration, the portable information terminal of the present invention in an embodiment is preferably configured such that the specific function is a rotating function for rotating a direction in which a screen is displayed on the touch panel in accordance with a position of the portable information terminal, and the switching means (i) disables the rotating function while a touch is being detected on the specific region and (ii) enables the rotating function while a touch is not being detected on the specific region.

With the configuration, in a case where a touch is detected on the specific region, the rotating function is disabled. Thus, even in a case where a user lies down while holding the portable information terminal as described earlier (the long side of the display is parallel to a median line of the user), the direction of the screen is not rotated so that display is easily viewable.

In addition to the configuration, the portable information terminal of the present invention in an embodiment is preferable configured such that the touch panel has a rectangular shape, and the specific region is made up of three strip-shaped regions along respective of two long sides and one short side of the touch panel.

With the configuration, even in a case where a user holds the portable information terminal in a vertical direction or a horizontal direction, a hand and/or finger(s) involuntarily touches the specific region.

In addition to the configuration, the portable information terminal of the present invention in an embodiment is preferably configured such that the specific region is made up of (i) a region which is like an icon and which is in contact with one of two long sides of the touch panel and (ii) a region which is like an icon and which is in contact with one of two short sides of the touch panel.

With the configuration, it is possible to switch between enabling and disabling of the specific function by touching the region which is like an icon, irrespective of whether a user holds the portable information terminal in a vertical direction or in a horizontal direction.

In addition to the configuration, the portable information terminal of the present invention in an embodiment is preferably configured to further include setting means for setting at least one of a position and a size of the region which is like an icon in accordance with a user's operation.

With the configuration, it is possible to customize a region which is like an icon in accordance with how a user holds the portable information terminal (holding form), and thus the user can naturally touch the extended region.

In addition to the configuration, the portable information terminal of the present invention in an embodiment is preferably configured such that the specific function is a backlight lighting function for turning on a backlight included in the touch panel, and the switching means activates the backlight lighting function when a touch is detected on the specific region and deactivates the backlight lighting function when a touch is not detected on the specific region.

With the configuration, the backlight is turned on only while a user is touching the specific region. In other words, the backlight is turned off while the user is not touching the specific region. The touching on the specific region corresponds to a state in which the user holds the portable information terminal, namely, a state in which the user is using the portable information terminal. With the configuration, the backlight is turned off while the user is not using the portable information terminal. It is possible to reduce power consumption of the portable information terminal and therefore to extend the operation hours.

In addition to the configuration, the portable information terminal of the present invention in an embodiment is preferably configured such that the specific function is a communicating function to communicate with another communication device, and the switching means (i) enables the communicating function while a touch is being detected on the specific region and (ii) disables the communicating function while a touch is not being detected on the specific region.

With the configuration, the communicating function is enabled only while a user is touching the specific region. In other words, the communicating function is disabled only while the user is not touching the specific region. The touching on the specific region corresponds to a state in which the user holds the portable information terminal, namely, a state in which the user is using the portable information terminal. With the configuration, the communicating function is disabled while the user is not using the portable information terminal. It is possible to reduce power consumption of the portable information terminal and therefore to extend the operation hours.

In order to attain the foregoing object, a method of controlling the portable information terminal of the present invention is a method of controlling a portable information terminal including a touch panel, the method including the steps of: (a) determining whether or not a touch on a specific region, provided in a peripheral part of the touch panel, is detected, and (b) switching, in accordance with a result determined in the step (a), between enabling and disabling of a specific function.

With the configuration, the specific region is provided in the peripheral part of the touch panel in which peripheral part a user involuntarily touches with his/her hand and/or finger(s) while holding the portable information terminal. As such, whether to enable or disable each function can be switched, without any particular operation, in accordance with whether or not the user holds the portable information terminal.

### INDUSTRIAL APPLICABILITY

The present invention is applicable to a portable information terminal including a touch panel. In particular, the present invention is suitably applicable to a mobile phone terminal, smart phone, PDA (Personal Digital Assistant), and tablet PC (Personal Computer).

### REFERENCE SIGNS LIST

1, 1′ Smart phone (portable information terminal)

2 Touch panel

3 Memory

4 Control section (setting means)

5 Acceleration sensor

8 Communication interface

10 Casing

20 Display

21 Touch sensor

22 Frame part

23 Input accepting section

40 Application executing section (switching means)

41 Position determining section

42 Touch determining section (touch determining means)

R Lock region (specific region, strip-shaped region)

R2 Extended region (specific region, region which is like an icon)

1-8. (canceled)

9. A portable information terminal comprising:
a touch panel;
touch determining means for determining whether or not a touch on a specific region, provided in a peripheral part of the touch panel, is detected; and
switching means for switching, in accordance with a result determined by the touch determining means, between enabling and disabling of a specific function, the specific function is a rotating function for rotating a direction in which a screen is displayed on the touch panel in accordance with a position of the portable information terminal.

10. The portable information terminal as set forth in claim 9, wherein:
the touch panel has a rectangular shape, and
the specific region is made up of three strip-shaped regions along respective of two long sides and one short side of the touch panel.

11. The portable information terminal as set forth in claim 10, wherein the specific region is made up of (i) a region which is like an icon and which is in contact with one of two long sides of the touch panel and (ii) a region which is like an icon and which is in contact with one of two short sides of the touch panel.

12. A portable information terminal as set forth in claim 11, further comprising setting means for setting at least one of a position and a size of the region which is like an icon in accordance with a user's operation.

13. A method of controlling a portable information terminal including a touch panel, the method comprising the steps of:
(a) determining whether or not a touch on a specific region, provided in a peripheral part of the touch panel, is detected; and
(b) switching, in accordance with a result determined in the step (a), between enabling and disabling of a specific function, wherein
the specific function is a rotating function for rotating a direction in which a screen is displayed on the touch panel in accordance with a position of the portable information terminal.

14. The portable information terminal as set forth in claim 9, wherein the switching means disables the rotating function while a touch is being detected on the specific region.

15. The portable information terminal as set forth in claim 14, wherein the switching means enables the rotating function while a touch is not being detected on the specific region.

16. The portable information terminal as set forth in claim 9, wherein:
the touch panel includes a display and a touch sensor;
an end of the display is located inside an end of the touch sensor; and
the specific region is provided within a width between the end of the display and the end of the touch sensor.

17. The portable information terminal as set forth in claim 9, wherein:
the touch panel includes a display and a touch sensor; and
the specific region is provided inside an end of the display of the touch panel.

18. The method as set forth in claim 13,
wherein, in the step (b), said disabling is disabling the rotating function while a touch is being detected on the specific region.

19. The method as set forth in claim 18,
wherein, in the step (b), said enabling is enabling the rotating function while a touch is not being detected on the specific region.
